(19) United States
(12) Patent Application Publication
(10) Pub. No.: US 2013/0111681 A1
(43) Pub. Date: May 9, 2013

(54) Clothing Wipe

(71) Applicants: Ben Kusin, Dallas, TX (US); Charles C. Steward, Midland Park, NJ (US); Ronald C. Griepenburg, Oradel, NJ (US); Edgardo Guce, New Milford, NJ (US)

(72) Inventors: Ben Kusin, Dallas, TX (US); Charles C. Steward, Midland Park, NJ (US); Ronald C. Griepenburg, Oradel, NJ (US); Edgardo Guce, New Milford, NJ (US)

(21) Appl. No.: 13/724,883

(22) Filed: Dec. 21, 2012

Related U.S. Application Data
(63) Continuation-in-part of application No. 13/606,827, filed on Sep. 7, 2012.
Application No. 13/606,827 is a continuation-in-part of application No. 11/386,425, filed on Mar. 22, 2006, now abandoned.

(51) Int. Cl. B08B 1/00

(52) U.S. Cl. CPC B08B 1/006
USPC 15/104.93

(57) ABSTRACT

A clothing wipe as an exemplar of a wide variety of dry wipe products includes an applicator having a novel dry odor neutralizing formulation deposited on one layer that is bonded to another layer to form a finger or hand mitt. The portable, reusable applicator may be removed from a pouch and rubbed against a person's clothing, or other surface intended to be freshened or cleaned of odors, that may have accumulated a variety of smoke, food, and other odors during an outing or during use. The odors clinging to the clothing or surface are neutralized by contact with the dry odor neutralizing formulation transferred from the applicator. A method of fabricating the clothing wipe in a web process is disclosed.

### RELATED APPLICATIONS

The present application is a Continuation-in-Part of U.S. patent application Ser. No. 13/606,827 filed Sep. 7, 2012 by the same inventors and entitled CLOTHING WIPE; which is a Continuation-in-Part of U.S. patent application Ser. No. 11/386,425 filed Mar. 22, 2006 entitled ODOR NEUTRALIZATION APPARATUS AND METHOD, now abandoned. The present application is also related to U.S. patent application Ser. No. 13/679,563 filed Nov. 16, 2012 by the same inventors, which is a Continuation of the above application and is also entitled CLOTHING WIPE.

### 1. FIELD OF THE INVENTION

The present invention generally relates to neutralizing unpleasant odors and, more particularly, to apparatus and a method for neutralizing unpleasant odors that may cling to the surface of a person's clothing and refreshing the scent of the clothing.

### 2. BACKGROUND OF THE INVENTION

Dining out, attending concerts or dance performances, going to the theatre or to movies, going to parties, dances and celebrations, going to night clubs and other entertainment venues, or just hanging out with friends are some of the activities people engage in during their free time. Generally, in preparing to participate in these activities, people take great pains to look their best and to present themselves in the best possible light. Personal grooming aids and products are often employed, most of which are scented, in an effort to appear attractive. Perfumes and scented grooming products are used to enhance the effects, particularly among persons interested in attracting other persons of the opposite sex, for example.

Unfortunately, the scented effects tend to diminish rapidly, reducing the intended effect of the personal grooming efforts. Further, many of the venues for the above activities include exposure to a wide variety of odors. These odors typically originate from food and beverages in restaurants, from smoke in restaurants, bars, night clubs, etc., from the perspiration of the persons themselves and other patrons, and from other substances that may be encountered during an evening's entertainment. Many of these odors are unpleasant or become more so with the passage of time. Such odors are readily absorbed by a person's clothing or hair, and are carried with the person for the rest of the evening. Thus, not only are the original scents diminished through the natural evaporation and deterioration that occurs, but they are often overwhelmed or masked by the many odors in the surroundings. These circumstances may be especially worrisome to people in a dating situation, especially as the evening wears on and the persons anticipate extending the evening or just wish to freshen themselves before proceeding with the remainder of the evening's activities, one's next appointment, etc. Other circumstances where the need to refresh one's clothing or hair may arise include following a long or arduous meeting, working out in a gym, a long walk between offices, playing with pets, and the like.

Conventional remedies include perfume or perfumed products such as cologne applied to a person's skin or clothing, typically provided in a spray container or a bottle. Other similar products may be applied by hand. Further, it is known that certain products, such as dryer sheets for use in clothes dryers, have sometimes been used in an effort to absorb the unpleasant odors from a person's clothing or hair, but generally with limited success. Further, such dispensing devices as traditionally used for perfume or cologne are not readily available with odor neutralizing capabilities adapted to neutralizing the odors accumulated on a person's clothing. Moreover, the use of paper or fabric odor absorbing devices has heretofore failed to provide more than limited usefulness.

It is known or has been observed that certain paper or fabric products, such as the Bounce® dryer sheets and Swiffer® floor mop products manufactured and distributed by the Proctor & Gamble Corporation for the laundry and floor cleaning markets respectively, and which may respectively contain anti-static or scented compounds or cleaning agents, have certain properties that might suggest possible applications in this field of odor neutralization of clothing. However, the available configuration of these articles is not appropriate or well suited to the application of neutralizing the odors absorbed by a person's clothing in a night club or restaurant venue. The Bounce® dryer sheets and the Swiffer® mop refills are loose sheets of fabric. They are not conveniently packaged for a person's pocket or purse, are not adapted to the particular use of odor neutralization of a person's clothing, and do not contain suitable substances for neutralizing odors absorbed into or clinging to a person's clothing or for refreshing originally applied perfumes or scents.

### SUMMARY OF THE INVENTION

Accordingly there is disclosed a personal care apparatus for neutralizing odors on a person's clothing. The apparatus comprises a hand-held applicator formed of a first layer and a second layer bonded together along mutual edges thereof except along a portion of the mutual edges thereby forming a pocket or sleeve; an odor neutralizing formulation uniformly deposited on an outer side of the first layer of the applicator, wherein the formulation includes a base component and a neutralizer component; the base component includes approximately 86% polyethylene glycol ester and 10% glycerin and the neutralizer component includes a fragrance mixture formed of essential oils and one or more aroma compounds combined in predetermined proportions; and a pouch for enclosing the applicator when not in use, the pouch formed of a flexible packaging film and having a reusable closure mechanism disposed along one side thereof.

In another embodiment, a method for fabricating a clothing wipe is provided, comprising the steps of forming a first layer of an applicator in a first branch of a web process including uniformly depositing an odor neutralizing formulation on an outer surface of said first layer; forming a second layer of said applicator in a second branch of a web process including imprinting said second layer with indicia followed by merging said first and second web process branches in a step for aligning said first and second layers of said applicator for cutting, trimming and bonding operations; and forming and imprinting a storage pouch for said applicator from flexible packaging film in a third web process followed by merging said third web process branch with said combined first and second web process branches in a step to insert said applicator in said storage pouch.

In another aspect of the method for fabricating a clothing wipe, the step of formulating the odor neutralizing formulation includes the steps of combining a fragrance mixture in a predetermined proportion to provide a fragrance component having a “clean linen” aroma; and combining the fragrance component with a base component including a mixture of a polyethylene glycol ester and glycerin. In another aspect, the polyethylene glycol ester is combined with the glycerin in respective proportions of 86% and 10% of the odor neutralizing formulation.

In another embodiment, there is disclosed an apparatus for neutralizing odors in clothing, comprising an applicator for applying a neutralizing substance to a person's clothing, the applicator including a carrier layer having a generally rectangular shape defined by a perimeter thereof and impregnated with the neutralizing substance, and a substrate layer having generally the same shape as the carrier layer and bonded to the carrier layer around all but a select portion of the perimeter of the carrier layer to form a finger pocket for manipulating the applicator. In an alternate embodiment, an activating mechanism or protective sleeve associated with the applicator may be provided for releasing the neutralizing substance from the carrier layer.

In another aspect of the invention, a method is disclosed comprising the steps of providing an odor-neutralizing applicator having a carrier layer impregnated with an odor neutralizing substance and adapted to be slipped over the person's fingertips of one hand; slipping the applicator over the fingertips of the person's hand; and manipulating the applicator against the person's clothing to neutralize the odors in the person's clothing. In an alternate embodiment the method includes the step of activating the carrier layer of the applicator to release the odor neutralizing substance onto the person's clothing.

In another embodiment of the present invention a clothing wipe is disclosed comprising a mixture of polyethylene glycol (PEG), glycerin, and a fragrance, said mixture deposited as a dry formulation on a surface of a handheld applicator. The PEG mixed with glycerin and a fragrance together form a dry odor neutralizing formulation, and the PEG having a molecular weight within the range of 2000 to 7000 g/mol.

In yet another embodiment a reusable clothing wipe for freshening a person's clothing comprises a handheld applicator having a first outer surface and a dry odor neutralizing formulation deposited on said surface of said applicator. The dry odor neutralizing formulation includes a base component and a fragrance component wherein the base component comprises a mixture of polyethylene glycol and glycerin.

### BRIEF DESCRIPTION OF THE DRAWINGS

FIG. 1 illustrates a plan view of one embodiment of an apparatus for neutralizing odors on a person's clothing;

FIG. 2 illustrates an edgewise view of the embodiment of FIG. 1;

FIG. 3 illustrates a pictorial view of the use of the embodiment of FIG. 1;

FIG. 4 illustrates a pictorial view of an alternate embodiment of an apparatus for neutralizing odors on a person's clothing;

FIG. 5 illustrates a graphical depiction of an odor neutralizing formulation for use with the embodiment of FIG. 4;

FIG. 6 illustrates a flow chart of one example of a method of manufacture of the embodiment of FIGS. 4 and 5;

FIG. 7 illustrates an alternate embodiment of the applicator pouch shown in FIG. 4;

FIG. 8 illustrates a first alternate embodiment of the applicator;

FIG. 9 illustrates a second alternate embodiment of the applicator; and

FIG. 10 illustrates a pictorial view of the use of the first or second alternate embodiments of the applicator.

### DETAILED DESCRIPTION OF THE INVENTION

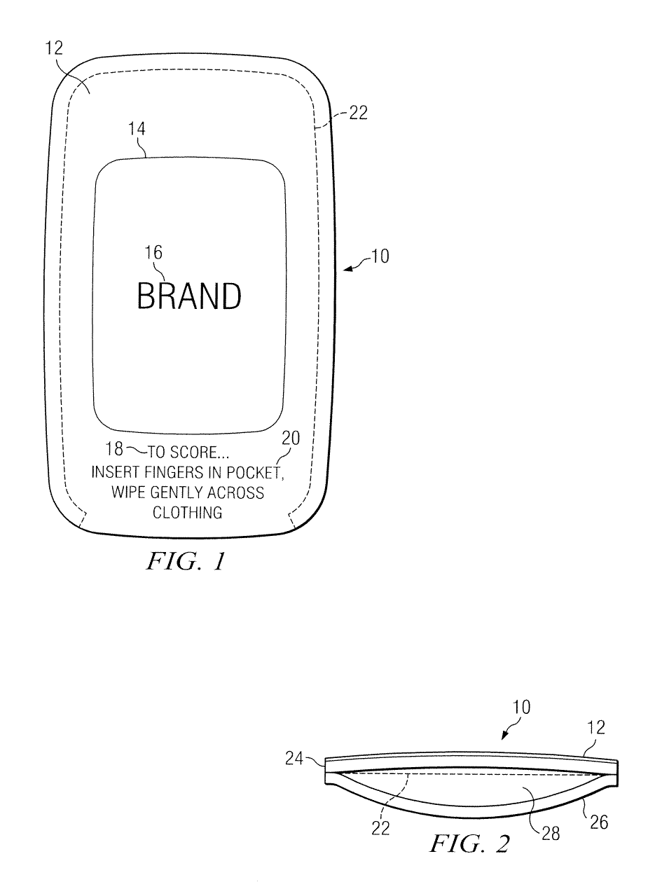

Referring to FIG. 1, there is illustrated a plan view of one embodiment of an apparatus for neutralizing odors on a person's clothing by refreshing the person's clothing through odor neutralization and new scent deposition. An applicator 10 includes a top layer 12, which may bear a brand indicia 14 including a brand 16, and, as one alternate embodiment, a textual indicia 18 including instructions 20 for using the applicator 10. In an alternative, wherein the top layer 12 includes only a brand indicia, textual indicia may be affixed to or printed upon the packaging for the applicator 10. A bonding region 22 is shown, indicating the location of a bond that is formed between the top layer 12 and other layers (not shown in FIG. 1) below the top layer 12. It will be observed, however, that the bonding region 22, between the edge of the applicator 10 and the dashed line, surrounds the perimeter of the applicator 10 around all of the perimeter except for one edge of the applicator 10. The edge of the applicator 10 that does not include a bond is selected so that a person's fingertips may be inserted between two of the layers, as will be explained.

The applicator 10 in its preferred embodiment is intended to be a compact device easily carried in a pocket or purse. Thus, its dimensions are determined accordingly to be slim and only slightly larger than a business card, for example. The applicator 10 in the illustrative embodiment shown in FIGS. 1, 2 and 3 may be approximately 3.75 inches long and approximately 3.00 inches wide. The top layer 12 may be a paper material bearing the indicia 14, 18, which may, for example, be printed or embossed thereon by conventional processes. In alternative embodiments, however, the dimensions and shape of the applicator 10 may of course be modified for other applications without departing from the concept illustrated in FIGS. 1, 2 and 3. In general, the shape may be any plane figure that is bounded by a closed perimeter, such as triangular, rectangular, circular, elliptical, oval or polygonal. The portion of the perimeter that is open, called the open space 28, to permit the users fingers to be inserted between a carrier layer 24 and a substrate layer 26 (See FIG. 2) in the manner of a finger mitt, may be located at any location along the perimeter of the applicator 10. In a preferred embodiment, the shape of the applicator 10 is generally rectangular with rounded corners, wherein the open space 28—an entry side for inserting the user's fingers—is located along one of the shorter sides of the applicator 10. Other embodiments may position the open space 28 along a longer side or a curved side.

Referring to FIG. 2, there is illustrated an edgewise view of the applicator 10. The structure of the embodiment shown includes three layers of material, each with a distinct purpose. The top layer 12 has been described previously. It may be bonded fully to an intermediate substrate layer 24, which may be fabricated from a thin, generally flexible and substantially non-absorbent material that has some stiffness or resiliency to provide shape and “body” to the applicator 10. The purpose of the substrate layer 24 is to form a pocket in cooperation with the carrier layer 26 when the applicator 10 is prepared for use. Materials suited to this purpose include leather, synthetic, leather-like fabrics, heavy grade papers, and the like. The lower layer, the carrier layer 26, is preferably an absorbent layer of a non-woven fabric, such as may be formed of spun-bonded polyester fibers. This example, of which the fabric such as that used in the aforementioned dryer sheets is just one alternative, is illustrative only and a number of alternative fabric materials are feasible. The carrier layer 26 is preferably impregnated with an odor neutralizing substance to be described. In alternate embodiments, the carrier layer 26 may include pleasantly scented material such as perfume or cologne, either alone or in combination with the odor neutralizing substance.

The carrier layer 26 may be bonded to the substrate layer 24 around the perimeter of the substrate layer 24 except at the selected open space shown in FIG. 2. This open space is provided for the person using the applicator 10 to insert his or her fingertips into the pocket 28 between the carrier layer 26 and the substrate layer 24 for the purpose of manipulating the applicator 10 during use. The edge of the bonding region 22, represented by a dashed line (also indicated by reference number 22), is shown within the pocket 28 between the substrate 24 and carrier 26 layers. The dashed line 22, also shown in FIG. 1, may in one embodiment indicate one location of stitches for sewing the edges of the bonding region 22 together. The edges of the bonding region 22 may also be bonded using an adhesive, rivets, staples, clamps or crimped fasteners, or even be an integral part of both the substrate 24 and carrier 26 layers of the applicator 10. An example of the latter embodiment is provided when the substrate 24 and carrier 26 layers are formed of a single sheet of material that satisfies the requirements of both layers.

In some embodiments it is advantageous for the applicator 10 to be disposable; that is, it may be discarded when the odor neutralizing substance impregnated in the carrier layer 26 is exhausted. Thus, the materials used in the construction of the applicator 10 need not be particularly durable. On the other hand, it is further contemplated that other embodiments of the applicator 10 may be reusable. For example, an applicator 10 constructed of relatively durable materials and configured to be fitted with a replaceable carrier layer 26, may be provided. The latter embodiment might provide a marketing advantage in that the applicator may be provided at nominal cost with or without a package of refill carrier layers 26 (or, carrier sheets 26). A reusable applicator would include a bonding mechanism to enable removal of the carrier layer 26 for replacement by a fresh carrier layer 26.

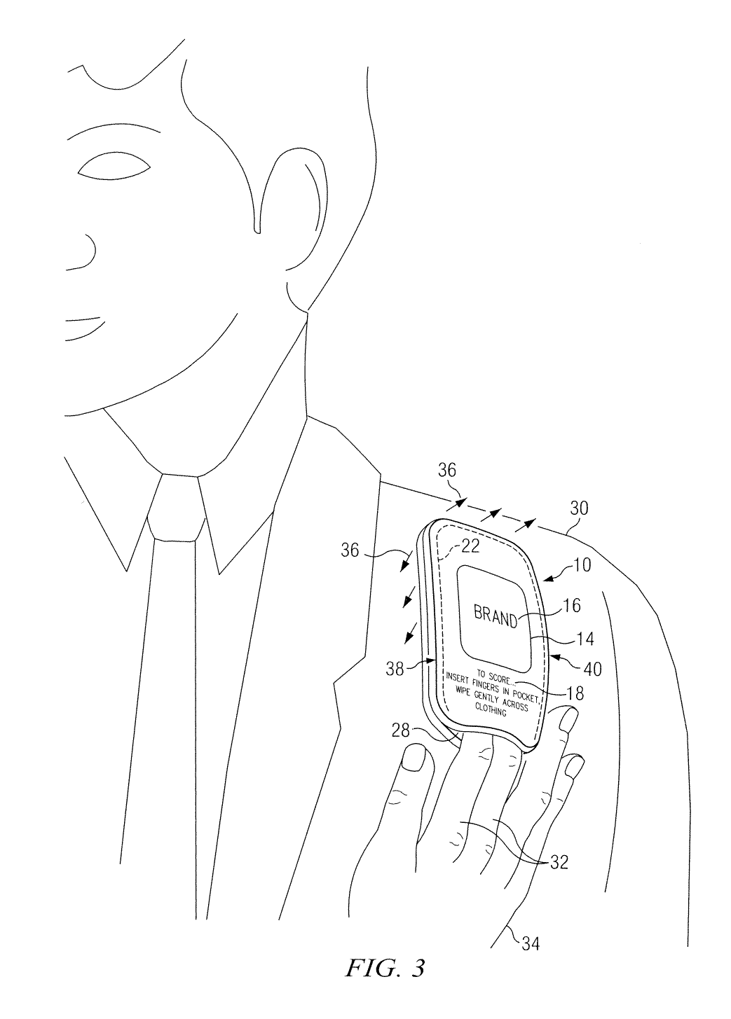

Referring to FIG. 3, there is illustrated a pictorial view of the applicator 10 being used to apply the odor neutralizing substance to a person's clothing. The applicator 10 is shown being manipulated by a wiping action against the clothing 30 of a user, as indicated by the arrows 36. The user's fingertips 32 of his or her hand 34 are inserted into the pocket 28 between the substrate 24 and carrier 26 layers of the applicator 10. In a preferred embodiment, the pocket 28 in the applicator 10, when opposite sides (e.g., to the left and right of the applicator 10 as indicated by the triangular marks 38, 40 in FIG. 3) of the applicator 10 are squeezed slightly, opens wide enough to receive two fingertips 32 therein for manipulating the applicator 10. Once installed on the user's fingertips, his or her hand 34 is moved in a side-to-side motion 36, rubbing or wiping the lower surface portion 18 (not visible in the figure, but will be readily understood) of the carrier layer 26. This action causes the release and transfer of the odor neutralizing substance from a portion of the carrier layer 26 to the surface of the user's clothing 30, as will be described further herein.

Continuing with FIG. 3, the odor neutralizing substance may, for example, be an activated charcoal material, impregnated into or formed into a fabric used to construct the carrier layer 26, that absorbs odor particles on contact with the carrier layer 26. In an alternative embodiment, a compound that combines with the chemicals in food odors and smoke, thereby causing them to be non-odorous, may be activated on contact with the person's clothing. In another alternative embodiment, a compound that volatilizes odorous substances on contact, causing them to disperse by evaporation may be used. Alternate embodiments may utilize a combination of these features in a single device to accomplish odor neutralization. For example, a device may combine the features of absorption and ionization to neutralize odors accumulating on the surface of clothing. Further, the odor neutralizing substance may be bound in microcapsules impregnated within the carrier layer, thus prevented from escaping until subjected to the pressure associated with the rubbing or wiping contact 36 against the user's clothing surface when the applicator 10 is being used. The odor neutralizing substance may additionally include a perfume or other scented agent. Alternatively, the perfume or scented agent may be separately impregnated into the carrier layer 26.

In one example, an activated charcoal material that is formed into a textile fabric having a microporous structure may be used in the carrier layer 26. The microporous structure provides a very large surface area presented to the odor-causing substances, effectively absorbing them from the person's clothing during use of the applicator 10. The activated charcoal textile material, developed in Britain for its filtering properties, is further disclosed in U.S. Pat. No. 6,313,371 issued to Conant et al.

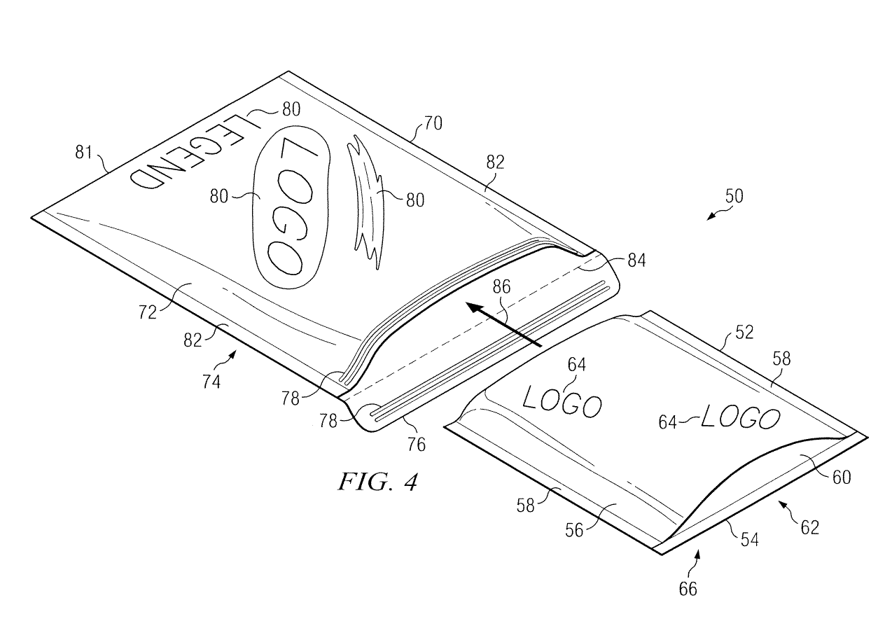

The following detailed description describes several alternative and preferred embodiments with reference to FIGS. 4 through 10.

In one preferred embodiment to be described with reference to FIGS. 4, 5, 6, and 7, the odor neutralizing substance may include a formulation comprising a base component and an organic odor neutralizer component combined in predetermined proportions. In the illustrated example, the base component may comprise a mixture of a polyethylene glycol ester and glycerin, in approximate respective percentages of 86% and 10%. The polyethylene glycol (PEG) ester, a soft, colorless material is provided as a base component—a carrier—that provides sufficient body to the formulation to hold the odor neutralizer component in a solid matrix. When the clothing wipe device is rubbed along the surface of the clothing, a thin film of the carrier or base, with the neutralizer combined therewith, is deposited on the surface of the clothing. This film leaves no stain and may be removed when the clothing is washed. The glycerin is soluble in the base and provides a softening effect on the base, while slowing the release of the fragrance component of the odor neutralizer to be described. The glycerin is also washable and leaves no stain, and has a low vapor pressure so that the stability and shelf life of the device are enhanced.

The organic odor neutralizer component may comprise a fragrance component or mixture or composition. This component comprises approximately 4% of the total odor neutralizing formulation. Fragrance mixtures are well known and are available in a wide variety of formulations or types, for neutralizing a wide variety of odors. Some of the available types include: a masking agent, a solvent, an absorbant, an encapsulant, and a spray dry fragrance. In the present invention, one class of fragrance compositions or mixtures has been found particularly suitable for counteracting or neutralizing odors on clothing or a person's hair, for example. Such a fragrance mixture is a blend of several constituents that is formulated to present—i.e., leave behind on the user's clothing—a “clean linen” aroma or scent. In the illustrated embodiment, the constituents of the fragrance mixture may include chemicals of an aromatic or aliphatic nature such as aldehydes, ketones, alcohols, esters, and materials containing oxygen, nitrogen or sulphur. The fragrance mixture are preferably comprises approximately 4% of the total odor neutralizing formulation. However, due to the subjective nature of the sense experience, this proportion may be varied by experimenting with the proportions to be mixed. For example, the test may begin by varying the ingredients in greater or lesser proportion until a preferred proportion is determined for a particular application.

In regard to the proportions of the three principal ingredients of the odor neutralizing formulation described above in specific percentages, it is important to point out that these are percent values arrived at for one embodiment of the illustrated clothing wipe. The clothing wipe may be configured for a variety of specific applications depending on the market for such variations. Accordingly, the proportions of the these ingredients may be varied to suit particular formulations to meet a specific target market segment. In general, the proportion of the polyethylene glycol ester may range from 80% to 90%, the glycerin (or an acceptable substitute) may range from 6% to 16%, and the fragrance mixture may range from 0.5% to 10%. Potential market segments may be gender-specific or unisex, or directed to particular kinds of activities such as indoor or outdoor, social or business or recreation, etc. Other applications may include clothing wipes that are formulated as insect repellants or other ancillary uses besides refreshing the scent or odors present on a person's clothing or hair. Such applications may include ingredients that are combined in proportions that differ substantially from those set forth herein. For example, a wipe having an insect repellant substance may include 15% to 30% repellant chemical in combination with a base component of 70% to 85% and a fragrance mixture of a few percent, for example. Other applications may include wipes having formulations adapted to a person's skin surfaces. Such applications may include ingredient formulations based on other types of ingredients in other proportions, etc. Thus, the clothing wipe described herein is only one example of a versatile delivery system for scented or other chemical formulations configured for a wide variety of personal care products.

In use, as described herein below, the rubbing action that occurs when the clothing wipe device is brought into contact with the user's clothing or hair and deposits the odor neutralizing formulation or substance in proportion to the degree of force used and the length of path or amount of time expended as the device is rubbed across the surface of the clothing. This provides a convenient way to regulate the amount of odor neutralizing formulation deposited during use, thereby affecting the strength and noticeability of the fragrance and the effectiveness of the clothing wipe device described herein.

Manufacturing the clothing wipe device may be illustrated by a simple sequence of steps. Both the applicator and the pouch may be supplied in bulk as thin fabrics and packaging film respectively. Each one may be imprinted in bulk web-processing facilities prior to cutting and bonding the individual pieces that will be assembled to form the applicator or the pouch. Imprinting may be used to apply logo and other indicia, as well as instructions for use and/or attractive graphics, to the pouch. The fragrance mixture may also be applied during a bulk web-processing process by depositing the compound odor neutralizer material in a slot-dye coating process, well-known in the art. In this process, the formulated mixture is placed into a reservoir such as a hopper device and conveyed to a distributing device that has a narrow slot orifice oriented across the width of the fabric that is to receive the mixture. The slot has a length approximately equal to the width of the fabric, and deposits a measured layer of the odor neutralizer formulation onto the surface of the bottom, active (first) layer of the applicator.

Materials for the bottom (first) and top (second) layers of the applicator are selected for the abilities to be imprinted, bonded ultrasonically, and fabricated in a web-processing process as will be described. The bottom layer of the applicator may be a single ply of a non-woven (e.g., spun-bound) polypropylene fabric or a two-ply combination of a non-woven polypropylene fabric having a weight of approximately 160 g/m² weight and a rayon fabric that is needle punched in a predetermined pattern over the area of the layer to secure it to the polypropylene fabric. The total thickness of the two-ply layer may then have an approximate thickness of 0.10 inch or less. In a single layer embodiment the additional step to bond the rayon or other fabric layer may be deleted. The top layer of the applicator may preferably be a non-woven (e.g., spun-bound) polypropylene fabric of approximately 100 g/m² weight and a thickness of approximately 0.013 inch. These weights/thicknesses are approximate and selected for the size and weight appropriate to the look and feel of the hand-held clothing wipe device described in this example. Other materials may be selected as long as they have the properties suited to the application. For example, certain alternate embodiments intended for heavy-duty service may be fabricated of heavier weight materials or synthetic fabrics of greater durability.

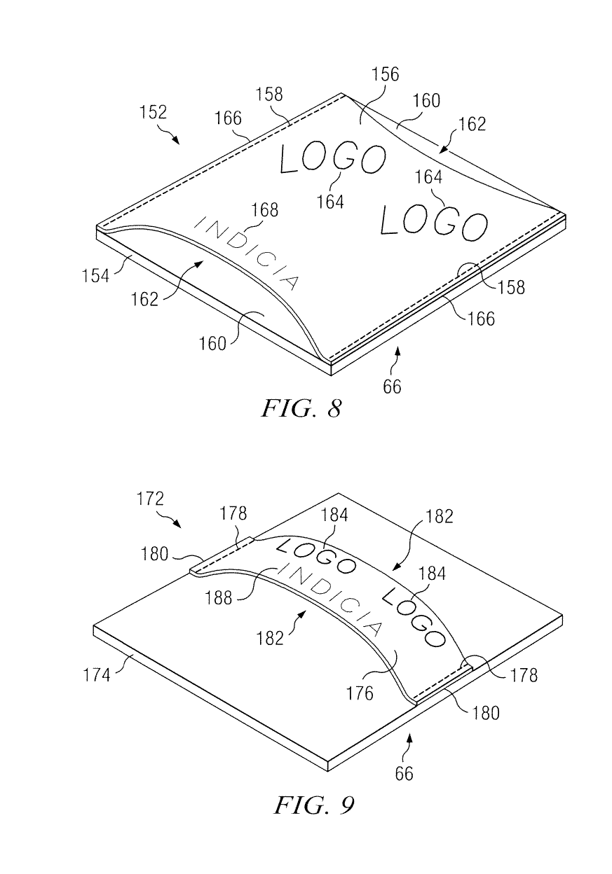

In the embodiment of FIGS. 4-7, the two layers, after imprinting, depositing the odor neutralizer to the bottom layer and cutting to size, may be ultrasonically bonded around the perimeter except for along one edge, allowing the one edge to remain open, thereby forming a pocket so that the applicator may be slipped over a user's fingers during use. The bottom layer may preferably be provided in a color different from the top layer to facilitate identification of the correct side of the applicator to apply to the user's clothing. For example, the bottom layer may be white and the top layer imprinted with the logo, etc. in other colors. In another embodiment to be described with reference to FIGS. 8-10, two opposite edges of the applicator are left open—unbonded—thereby forming a sleeve for the user's fingers.

The storage pouch may be manufactured from a flexible packaging film that is imprinted with graphics, logos, legends, indicia, instructions for use, etc. As is well known, flexible packaging film is available in many forms depending on the kind of product to be contained therein and the kind of graphics imprinted on the outside layer, etc. In the illustrated example, the packaging film, which should be adapted to containing personal care products, may be a laminated product whereby each layer of the material is selected to provide the particular properties desired in the package. Such flexible packaging film products are typically laminated of multiple layers of thin film materials such as a coated and printable outer layer to support printed graphics (e.g., polyester), low density polyethylene (LDPE), a metal foil, a linear low density polyethylene film (LLDPEF), and the like. These materials may be provided in thicknesses that range from 0.25 to 1.5 mil (1 mil= 1/1000 of an inch). In the embodiment described herein the total thickness of the film packaging material may be approximately 3.5 mil. These materials in combination provide sufficient body, moisture and puncture resistance, resistance to tearing, the effects of light, etc.

As shown in FIG. 4 the storage pouch 70 includes a closure mechanism along the one side or edge of the pouch that does not have a bound or welded edge along its perimeter. This open edge may be resealed to enclose the applicator therein when not in use so that the odor neutralizing capacity is preserved. One preferred closure mechanism is to provide the open edge with a string zipper—a flangeless zipper—or its equivalent. The locking members of the string zipper are sealed to the edges of the opening to be closed or opened. As is well-known, a string zipper allows for reclosing a package without requiring a separate traveling slider to zip or unzip the package. String zippers may be molded from polyethylene or other similar materials. Another closure mechanism is illustrated in FIG. 7. In this example the bottom layer of the applicator is extended past the opening along the edge of the applicator, thus forming a closure flap. A strap of the same material used for the top layer may be attached parallel to the open edge on the outside of the applicator and spaced slightly away from the open edge of the applicator to serve as a retainer for the closure flap.

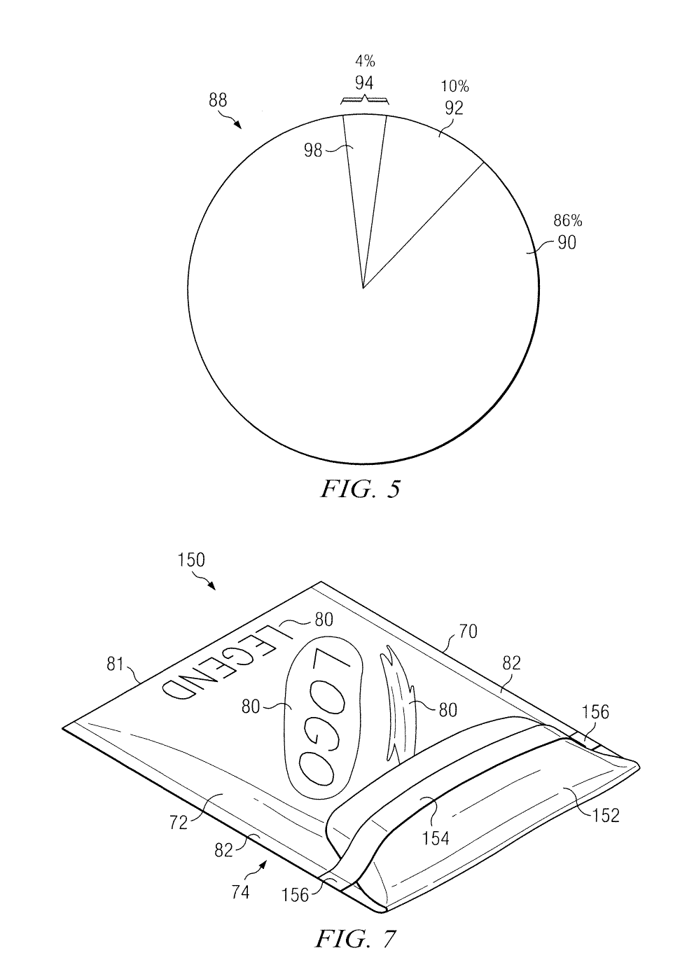

FIG. 4 illustrates a pictorial view of an alternate embodiment of an apparatus for neutralizing odors on a person's clothing. This personal care product 50 includes an applicator 52 and a pouch 70. The applicator 52 is formed by bonding a bottom layer 54 of a suitable material to a top layer 56 of a suitable material along its edges 58 except for one edge 60 that is left open 62, thereby forming a pocket in the space between the top and bottom layers to enable a user to insert at least two fingers therein during use. Thus, in this embodiment, the first and second layers are bonded together along mutual edges thereof, except along a portion of the mutual edges—e.g., on one side or edge—thereby forming the pocket. The applicator 52 may be imprinted with graphics such as brand name or logo indicia or other decorative features. The bottom layer 54 of the applicator 52 further includes an odor neutralizing formulation 66 applied-to or embedded or impregnated into the outer surface of the bottom layer 54. The formulation 66 is further described in FIG. 5.

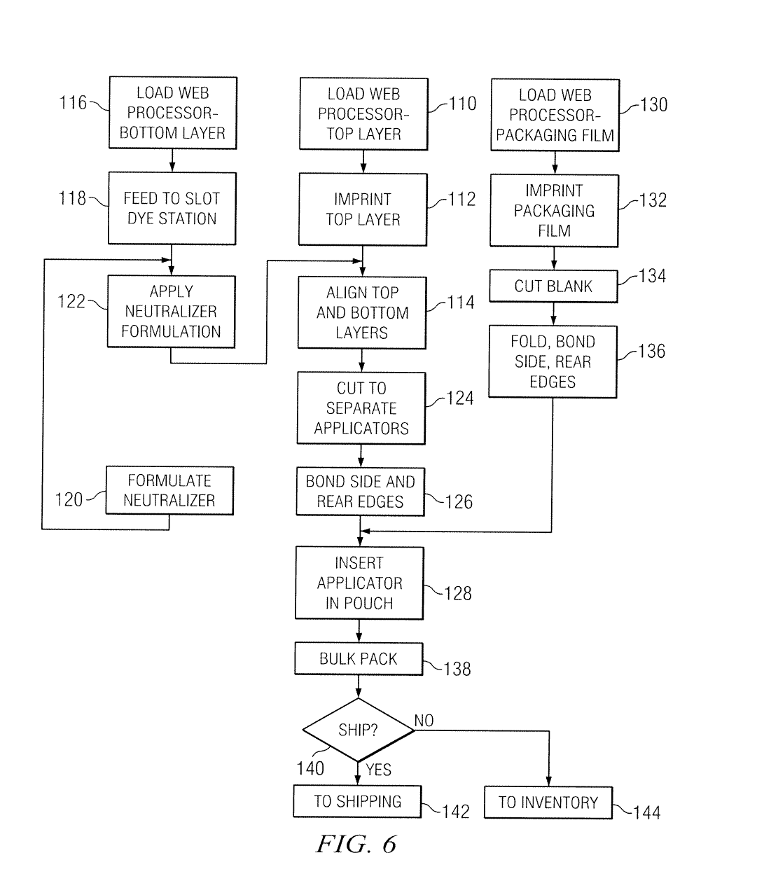

Continuing with FIG. 4 a pouch 70 for storing the applicator 52 in when it is not in use is shown. The storage pouch 70 may be formed of a single sheet of flexible packaging film as described herein above, folded along an edge 81 and bonded along opposite side edges 82. The fabrication process is shown in FIG. 6 to be described. The pouch 70 includes a top side 72, a bottom side 74, and a closure flap 76 extending from the bottom side 74. The pouch 70 may also include graphics 80 such as decorative features, brand name, or logo indicia imprinted on the outer sides of the pouch. In the embodiment shown a string zipper 78 is provided as a first part on the underside of the closure flap 76 and a second part on the outer surface of the top side 72 of the pouch 70. The closure flap 76 may be folded along the dashed line 84 until the two parts of the string zipper 78 are placed in contact and pressed together. As is well-known, a string zipper is a reusable fastener for a package that includes complementary molded ridges that may be pressed together to seal the zipper. To open the package a user need only grasp the top and bottom sides along the string zipper 78 and pull the sides 72, 74 at their open edges apart to separate the ridges of the fastener.

FIG. 5 illustrates a graphical depiction of an odor neutralizing formulation 88 for use with the embodiment of FIG. 4. In FIG. 5, a base component may be formed of a mixture of polyethylene glycol ester 90 (PEG ester) and glycerin 92, mixed together in approximate proportions 16 (of the total odor neutralizing formulation) of 86% and 10% respectively. The polyethylene glycol 17 (PEG), which comprises most of the odor neutralizing formulation, is used as a thickening agent and a carrier or vehicle for delivery of the malodor counteractant. The molecular weight of the polyethylene glycol should generally be within the range of 2000 to 7000 g/mol (grams per mole), and preferably approximately 4000 g/mol. One example of the principal ingredient of a suitable base component or thickener is a product named Mapeg® 6000 DS PEG (6000) Distearate, which is available from the BASF Corporation, Florham Park, N.J. 07932. This product, which has an average molecular weight of 6000 g/mol, is a polyethylene glycol ester widely used in soaps and other products as emulsifiers, stabilizers, viscosity control agents, and the like. There is also a variety of versions of this product available in various molecular weights and other parameters, etc. One suitable PEG that is preferred for the present invention is a product called Carbowax™ Polyethylene Glycol (PEG) 4000, which has an average molecular weight of 3600 to 4400 g/mol. Further information about this product is available at www.carbowax.com and is manufactured by The Dow Chemical Co. of Midland, Mich., 48640.

The glycerin 92 component is included in the formulation to soften the PEG somewhat to enable smooth application of the odor formulation 88 on the user's clothing. Substitutes for the glycerin 92 may include other poly alcohols or long chain poly oils well-known in the art. The combination of the PEG 90 and the glycerin 92 enables slower, more uniform release of the fragrance mixture (to be described). The purpose of the base component 90, 92 is to provide a solid but soft carrier or delivery vehicle for the fragrance mixture. The base component also provides a barrier to the escape of bad odors (“malodors”) from the fabric of the person's clothing or the person's hair by providing a thin, transparent, colorless film upon the surface being wiped, yet is washable and leaves no stain.

The odor neutralizer component 94 makes up the remaining 4% of the odor neutralizing formulation 88. One reason for the relatively small percentage—approximately 4%—used in the illustrated embodiment is that typically only a very small amount of a malodor substance is very noticeable. Accordingly, only a very small amount of a counteracting fragrance may be needed to be effective in neutralizing the malodor. Further, it is possible for a limited amount of a fragrance blend or composition to counteract a malodor or to neutralize an odor. For example, in an aroma compound based on an aldehyde, the aldehyde may react with nitrogen in a malodor to form what is known in the art as a “Schiff Base” product that “ties up” the nitrogen malodor materials, thereby reducing the perception of the malodor.

Continuing with FIG. 5, in the illustrated embodiment the odor neutralizer component preferably includes a fragrance mixture 94 formulated from an essential oil in combination with at least one aroma compound to provide an odor characteristic that matches the desired odor paradigm. The aroma compound, such as the aldehydes, ketones, alcohols, or esters, as is well-known, react easily with the elements that are found in malodors—i.e., oxygen, nitrogen, and sulphur. A particular choice of aroma compound may be one of several that would be suitable for the type of clothing wipe 50 described herein. Thus, a preferred choice would be primarily a matter of (a) how the aroma compound reacts with other materials and (b) the desired subjective criteria associated with the scent of the aroma compound. As is well-known, an aroma compound typically may include many ingredients, combined in a proportion to yield a particular aroma or scent, in varying degrees of strength or intensity, duration of effects, etc., to name just a few kinds of characteristics.

In the present formulation these aroma compounds may include chemicals of an aromatic or aliphatic nature such as aldehydes, ketones, alcohols, esters, and/or materials containing oxygen, nitrogen or sulphur. One example of a fragrance mixture is perfume, which is a mixture of essential oils, aroma compounds, fixatives, and solvents, each selected to yield a desired particular effect. In the present invention, a fragrance mixture that presents a “clean linen” scent is suggested as one non-limiting example of many possible fragrance mixtures and fragrance paradigms that may be used in a device of the type described herein, including active scents (typically associated with masculine users) and floral scents (typically associated with feminine users) for example.

FIG. 6 illustrates a flow chart of one example of a method of manufacture of the embodiment of FIGS. 4 and 5. As is well-known, many products made from thin film or fabric materials may be suitably processed on web processing facilities. Web processing typically receives material from a bulk roll of material and may include mechanisms in various sequences for imprinting, coating, folding, bonding, depositing other substances thereon, cutting, filling, laminating, etc. Such processes are among those suitable for manufacturing both the applicator 50 and the pouch 70 described herein in FIG. 4. FIG. 6 depicts one such process applied to fabricate both the applicator 50 and the pouch 70. The method employs several web processing lines that begin with individual components of the clothing wipe, wherein the separate web processing lines or branches are merged in a single step to combine the individual processing lines or branches to join together two components of the finished product. This merging step may occur more than once, as illustrated in FIG. 6.

Continuing with FIG. 6, the flow for fabricating the applicator may begin at step 110 to load the web processor with the material for the top layer 56 of the applicator 52 followed by step 112 to imprint the top layer 56 with selected indicia or graphics 64 before sending the imprinted material to step 114. In a parallel process the material for the bottom layer 54 is loaded into a separate branch of a web processor in step 116 for forwarding via step 118 to feed the bottom layer material through a machine such as used for a slot dye process to deposit measured amounts of the odor neutralizer formulation 66 onto the surface of the bottom layer 54. The odor neutralizer formulation 66 may be prepared in a step 120 and advanced to step 122 to be applied to the bottom layer 54 of the applicator 52.

As is well known, a slot dye process is adapted to dispense a measured amount of a substance from a narrow slot opening across the width of a moving belt of the film or fabric to be coated or imprinted. As readily understood by persons skilled in the art, alternatives to the slot dye process exist that also deposit a uniform coating of a material in fluid, powder, or granular form upon the surface of a fabric. The choice is best made to suit the particular form of the product being fabricated. The slot dye process is described as one readily understood method of applying a uniform coating of material to a surface of an object.

Following deposit of the odor neutralizer formulation 66 the material for the bottom layer 54 is next prepared to be aligned with and joined to—i.e., merged with—the material for the top layer 56 in step 114. Following alignment, the flow advances to step 124 wherein the line of applicators formed to that point may be cut into separate applicators 52 followed by bonding the side and rear edges 58 of the aligned top 56 and bottom 54 layers together in step 126. Such bonding may utilize an ultrasonic bonding process to bond the edges of the top 56 and bottom 54 layers to each other, thereby forming an applicator 52 that may be worn as a small pouch or finger mitt as depicted in FIG. 3, or a sleeve as illustrated in FIGS. 8-10 that is slipped over the user's fingers. After the bonding step 126 the completed applicator 52 may be merged with the storage pouch 70 in step 128 and inserted into a storage pouch 70. The storage pouch 70 may be fabricated in a similar way to be described. In the bonding step, several alternative processes may be used including continuous ultrasonic, uniform discontinuous ultrasonic, and a stitched bond. The stitched bonding may be stitched with a thread material or be simulated by an intermittent (discontinuous) ultrasonic bonding.

Beginning at step 130 with loading the flexible packaging film for fabricating the pouch 70 the flow advances to step 132 to imprint the flexible packaging film with indicia such as product or brand name, logo, colorful graphics, instructions for use, other text to comply with regulatory requirements, etc. following imprinting, the imprinted film passes through a station to cut the blanks of the pouch 70 to size in step 134 before being folded, and the aligned side edges are bonded, again by an ultrasonic process, for example. The completed storage pouch 70 is aligned to merge with the completed applicator 52 in step 128, wherein the applicator 52 is inserted into the pouch 70, including folding over the flap 76 to seal it against the top layer 56 by pressing the two sides of the string zipper 78 together or otherwise securing the closure. The process may then deliver the finished clothing wipes 50 to a bulk packing station 138 to prepare them for shipment. Typically the clothing wipes manufactured as described may be packaged in quantities of one dozen to multiples of a dozen, for example. The packed products may proceed to a station 140 that tests whether the package is to be shipped immediately in step 142 according to an order or transferred to inventory in step 144. At this point, the flow ends.

As will be readily understood, the example of the fabrication process depicted in FIG. 6 is merely illustrative of one of several possible ways that the manufacture of these clothing wipe products may be accomplished. As noted herein above, the clothing wipe is a delivery vehicle well-suited to a wide variety of applications for delivering chemical-based products to the surface of a person's clothing or hair or skin. Its structure, regardless of the particular chemical formulations applied to the bottom layer of the clothing wipe, is thus basically the same as that described herein and adapted to being fabricated in the processes described and illustrated herein.

FIG. 7 illustrates an alternate embodiment 150 of the applicator storage pouch 70 shown in FIG. 4. As in FIG. 4, the pouch 70 may be formed of a single sheet of flexible packaging film as described herein above, folded along an edge 81 and bonded along opposite side edges 82. The basic fabrication process as shown and described in FIG. 6 may be used. The pouch includes a top side 72 and a bottom side 74, and may also include graphics 80 such as decorative features, brand name, or logo indicia imprinted on the outer sides of the pouch. In the embodiment of FIG. 7, a closure flap 152 extends from the bottom side 74. A retaining strap 154 for the flap 152 extends from each side edge 82 of the pouch where it is bonded to the respective side edge 82 at the locations 156 shown in FIG. 7. The flap 152 provides for closing and opening the pouch 70. Persons skilled in the art will realize that other closure methods or mechanisms are possible such as other types of zip fasteners, releasable adhesives and the like.

FIG. 8 illustrates a first alternate and preferred embodiment of the applicator. In this embodiment of the applicator 152, both ends of the applicator 152 are open, thereby forming a sleeve to permit the user's fingertips to extend beyond the end of the applicator. Further, the bonding of the bottom 154 and top 156 layers on either side edges 166 of the applicator 152 is indicated by the dashed lines 158. Indicia 168 are shown on the top layer 156. The same materials are used in the fabrication of this embodiment as the embodiment of FIG. 4 but the structure is slightly different, reflecting improved utility and only one of several other possible variations.

Continuing with FIG. 8, the applicator 152 is formed by bonding a bottom layer 154 of a suitable material to a top layer 156 of a suitable material along first and second side edges 166, leaving both ends 160 open—i.e., forming a sleeve by providing a passage between the first and second layers—to enable a user to insert at least two fingers in and through the space or passage 162 between the layers 154, 156 of the applicator 152 during use. The feature of permitting the user's fingers to extend through the passage or sleeve 162 of the applicator 152 has been found to work well because the applicator 152 is less likely to slip off the user's finger during its use. The bonding of the top 156 and bottom 154 layers is indicated by the dashed lines 158 along the side edges 166 of the applicator 152. The dashed lines 158 may indicate the location of ultrasonic bonds or, alternatively, the stitches of a sewn binding. The applicator 152 may be imprinted with graphics 164 such as brand name or logo, or indicia 168 or other decorative features. The bottom layer 154 of the applicator 152 further includes an odor neutralizing formulation 66 embedded, impregnated, or other wise applied into or upon the outer surface of the bottom layer 154. The odor neutralizing formulation 66 is further described in FIG. 5.

FIG. 9 illustrates a second alternate embodiment of the applicator. In this embodiment of the applicator 172, both ends of the applicator 172 are open to permit the user's fingertips to extend through the space 182 between the bottom 174 and top 176 layers of the applicator 172. In this embodiment the top layer 176 is formed as a strap across the mid-section of the applicator 172. The bonding of the bottom 174 and top 176 layers on either side of the applicator 172 is indicated by the dashed lines 178, and indicia 188 are shown on the upper layer 176. This embodiment of the applicator 172 is a variation of the embodiment depicted in FIG. 8 that may be implemented to save cost, for example. The same materials are used in its fabrication but the structure is slightly different, reflecting one of several possible variations.

Continuing with FIG. 9, The applicator 172 is formed by bonding a bottom layer 174 of a suitable material to a top layer 176 or strap of a suitable material along both side edges 180, leaving both ends of the applicator 172 open to enable a user to insert at least two fingers in and through the space 182 of the applicator 172 during use. The feature of permitting the user's fingers to extend through the space 182 of the applicator 172 in the manner of a sleeve has been found to work better because the applicator 172 is less likely to slip off the user's finger during its use. The bonding of the top 176 and bottom 174 layers is indicated by the dashed lines 178 along the side edges 180 of the applicator 172. The dashed lines 178 may indicate the location of ultrasonic bonds or, alternatively, the stitches of a sewn binding. The applicator 172 may be imprinted with graphics such as brand name or logo, or indicia 188 or other decorative features. The bottom layer 174 of the applicator 172 further includes an odor neutralizing formulation 66 embedded or impregnated into or otherwise applied upon the outer surface of the bottom layer 174. The odor neutralizing formulation 66 is further described in FIG. 5.

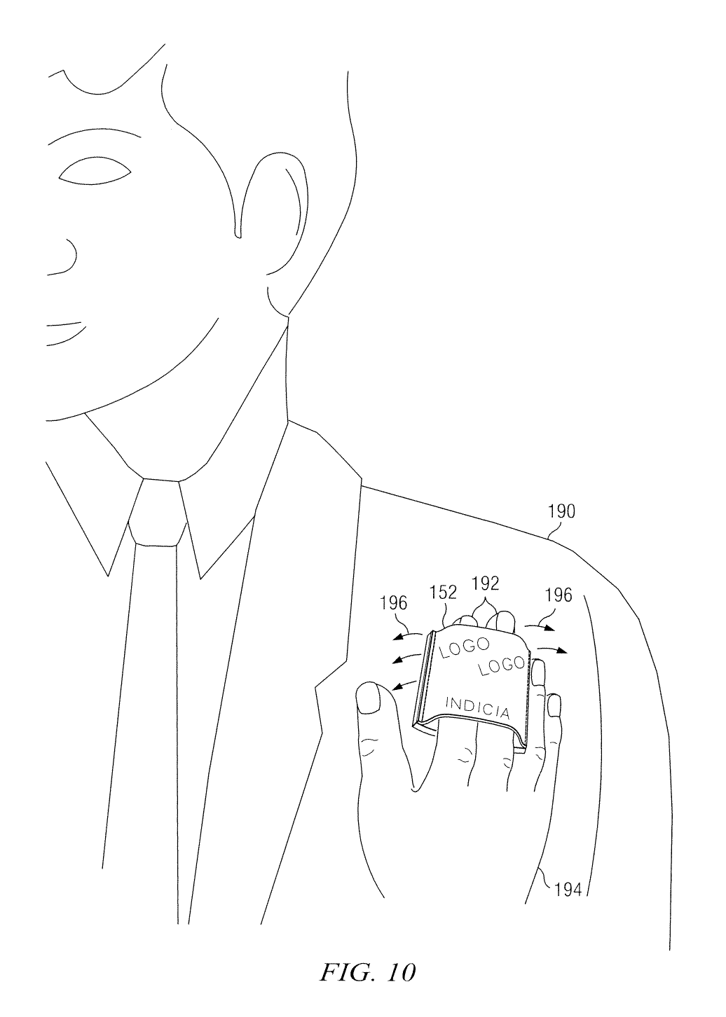

FIG. 10 illustrates a pictorial view of the use of the first or second alternate embodiments of the applicator. This view is similar to FIG. 3 except the user is shown with the embodiment of FIG. 8 in use. The use of the embodiment of FIG. 9 is similar. The applicator 152 is shown being manipulated by a wiping action against the clothing 190 of a user, as indicated by the arrows 196. The user's fingertips 192 of his or her hand 194 are inserted into the space or sleeve 162 between the bottom 154 and top 156 layers of the applicator 152. In a preferred embodiment, the space 162 in the applicator 152, when opposite sides 166 (See FIG. 8) of the applicator 152 are squeezed slightly, opens wide enough to receive two fingertips 192 therein for manipulating the applicator 152. Once installed on the user's fingertips, his or her hand 194 is moved in a side-to-side motion 196, rubbing or wiping the lower surface portion (not visible in the figure, but will be readily understood) of the bottom layer 154 against the surface of the clothing 190. This action causes the release and transfer of the odor neutralizing formulation 66 (See FIG. 5) from a portion of the bottom layer 154 to the surface of the user's clothing 190. An important attribute of the applicator 152 (and also other embodiments thereof as described herein) is that it enables a controlled release of the amount and strength of the fragrance component upon the user's clothing or hair when rubbed against these surfaces.

The applicators 10, including embodiments 52, 152, 172, and variations thereof, described herein above may be used multiple times and stored in a person's pocket or purse when not in use. However, in an alternate embodiment, the applicator 10 may be enclosed in a protective wrapper (See, e.g., FIG. 4) that is removed by the user prior to use. This wrapper or pouch may be configured to retard deterioration or prevent inadvertent dispersion of the odor neutralizing formulation or odor masking substances that may occur between uses. In another alternate embodiment, a protective layer of thin paper or plastic material having a low tack adhesive may be attached as a fourth layer (not shown) to the underside of the carrier layer 26. To activate the carrier layer 26, the user need only remove the fourth layer for use and replace the fourth protective layer over the carrier layer 26 after use. In a variation of this alternate embodiment, microcapsules of the odor neutralizing substance may be embedded in the adhesive that secures the protective layer to the carrier layer. Such microcapsules are well-known in the art for incorporating sample fragrances in periodical advertisements for the fragrance products. The microcapsules are ruptured when the protective layer is peeled away from the carrier layer, thus releasing or activating the odor neutralizing substance just prior to the use of the applicator 10. In another variation the fragrance mixture may be encapsulated in a starch compound, for example. Encapsulates act to retard the volatility of the fragrance mixture until it is released by contact or other action to open the encapsulate. Other mechanisms are spray dry fragrances, which can be deposited on clothing and released with friction against the fabric.

While the invention heretofore described has been shown in only one of its forms, it is not thus limited but is susceptible to various changes and modifications without departing from the spirit thereof. For example, the embodiment illustrated in the drawings is shown with the opening disposed in one of the longer sides of the applicator 10. In one modification (not shown because its appearance is readily visualized to one skilled in the art, based on the structural features shown in FIGS. 1, 2 and 3), the opening for receiving the user's fingertips may be provided in one of the shorter sides of the applicator, thus permitting insertion of the user's fingers to a greater extent to provide a firmer grip on the applicator 10.

In another modification, the applicator 10 may be enlarged such that a user's entire hand fits within the pocket 28 between the substrate 24 and carrier 26 layers. This configuration enables the use of the applicator as a hand mitt, for applying odor neutralizing substances to a larger fabric surface area, for example, such as to upholstery in vehicles or on furniture or draperies and curtains in offices or residences, etc.

As noted herein above, potential market segments for clothing wipes as described herein may be gender-specific or unisex, or directed to particular kinds of activities such as indoor or outdoor, social or business or recreation, etc. Other applications may include clothing wipes that are formulated as insect repellants or other ancillary uses besides refreshing the scent or odors present on a person's clothing or hair. Other applications may include wipes having formulations adapted to a person's skin surfaces. Such applications may include ingredient formulations based on other types of ingredients in other proportions, etc. Thus, the clothing wipe described herein is only one example of a versatile delivery system for scented or other chemical formulations configured for a wide variety of personal care products.

Yet another modification is to provide a pouch or sleeve 70 as described in FIG. 4 for enclosing and storing the applicator 10 within when not in use. Such a pouch or sleeve may also protect the carrier layer 26 from contact with other surfaces or substances that could degrade its functional characteristics. A sleeve could also be employed as part of a mechanism for activating the applicator just prior to use, if that is a particular objective of the product. In this embodiment, removing the applicator 10 from enclosure or contact with the sleeve may serve to activate the odor neutralizing substance for use.

In the following paragraphs several alternate embodiments are described: (A) A clothing wipe comprising: a mixture of PEG, glycerin, and a fragrance, said mixture forming a dry formulation deposited on a surface of a handheld applicator; (B) A reusable clothing wipe for freshening a person's clothing, comprising: a handheld applicator having a first outer surface; and an odor neutralizing dry formulation deposited on said surface of said applicator; and (C) A method for neutralizing odors on clothing, comprising the step of: transferring a dry formulation of polyethylene glycol (PEG), glycerin, and a fragrance from an applicator to the surface of a person's clothing, skin, or hair, or to other surfaces as will be described.

The more general form of the clothing wipe described herein may be adapted to a variety of applications, all of which embody the principles set forth herein and in the appended claims. The principle concept of the present invention, contrary to conventional practice in the industry that typically teaches complex combinations of numerous ingredients, is of a dry formulation of the combination of only three ingredients in carefully selected proportion and applied to the applicating surface of a wipe applicator that fits on a person's fingers or hand. The wipe is small, portable, reusable, convenient, and inexpensive to manufacture and use. From the foregoing description and further details to follow it is important to understand that the wipe described herein contains and is specifically adapted to dispense a dry formulation onto the intended surface, to avoid leaving any stain or residue that cannot be washed by conventional means. This is in distinct contrast to conventional wipe products heretofore available that are typically characterized, and limited to, the use of dry formulations that must be activated with water before use, or the use of wet formulations, some of which leave a residue that is difficult to remove or which can even damage the surface finish if applied too copiously or with improper technique. Such wet formulations would be inappropriate for the uses disclosed herein because of the risk of stains, damage or harm to the surfaces contemplated for the present dry wipe invention.

The embodiments described in detail herein are provided to illustrate without limitation the concepts or principles of a dry wipe system for dispensing or delivering a malodor counteractant to a surface that a person wishes to freshen. As one example, any fragrance that can be delivered by the applicator may be used, from among the hundreds available. The clothing wipe can be used in a variety of scenarios or locations in which clothing is subject to picking up different kinds of odors such as an indoor dance event, a night club, an athletic event, a downtown (out of doors) event, movie theatres—any number of places that may have characteristic odors that a user might want to counteract with the clothing wipe. The wipe could also be used to “freshen” a user's skin and/or hair after an active dance or other circumstance where perspiration is likely to arise.

Some of these characteristic odors might be: perspiration, other perfumes and fragrances, automobile exhaust, cooking and food odors, tobacco smoke, mildew, popcorn, etc. Neutralizing these odors may require different scents or different proportions of the constituents of the scent. For the example of strong or noxious odors, either a higher % of fragrance or a fragrance that provides more complete masking would be suitable.

Another example provides a wipe that replicates a user's cologne or perfume so as to refresh his or her's own “scent.” For instance, a cologne or perfume customer could receive an applicator packaged or supplied with a cologne or perfume product that is already prepared for use or that the customer could prepare by adding the cologne or perfume themselves before going to an event.

As yet another example, the wipe can be used by workers in industrial settings, such as automotive repair, machine shops, paint shops, kitchens, bakeries, butchering facilities, feed stores and the like—that is, any work environment that contains strong or unpleasant odors. In such cases, where the workers may need to mingle or meet with customers or executives, a clothing wipe may be used to advantage.

Extending the scope of the concept and principles described herein, one may be led to uses of the dry wipe, as distinguished from so-called wet wipes that are well known in the art, to freshen household surfaces such as furnishings and countertops, to wipe the fur of pet animals such as dogs, cats or other animals, and to freshen the interior surfaces of automobiles, trucks, airplanes and other vehicles, for example. The fragrances selected or developed and the size of the applicator may be adapted to each specific application. In most applications a scented fragrance to match the particular odor neutralization task is important; in some other applications a formulation that is unscented or provides only a very slight scented presence may be preferable.

Referring to FIGS. 4 through 10, previously described for an exemplary embodiment to illustrate the concepts of the invention, persons skilled in the art will recognize that a number of alternate embodiments are possible, either identical with or are close structural equivalents or derivatives of the embodiment illustrated in the figures. Accordingly, reference to the figures as previously described should enable persons skilled in the art to readily understand the structures of the various alternative embodiments to be described herein below.

For example, in the dry clothing wipe described, the fabrics used to form the applicator, the odor neutralizing formulation deposited on the surface of the applicator, and the scent provided by the formulation use materials, ingredients, and have characteristics that may be varied within the overall concept of the illustrated embodiments—a personal care or wipe device that is configured for delivering a dry odor neutralizing formulation from a convenient, reusable applicator to a person's clothing, hair, or skin or other intended surface.

Selection of the fabric for the applicator may be from among a wide variety of materials, as long as they are not hydrophobic, that is, the fabric must have an affinity for water. The fabric chosen for the applicating surface of the wipe must be able to receive deposition of the dry formulation on it during manufacturing, retain it without significant absorption during storage or non-use, and disperse it readily but controllably onto the target surface when it is wiped against it. Other essential properties or characteristics may include color, surface texture or roughness, and so forth, as will be described.

Further, the fabric chosen must be low in cost, which favors non-woven fabrics made by such processes as spun bonding, or pressing the fibers together. Moreover, the fabric must be suitable for automated manufacturing processes, including machine operations such as cutting, bonding of pieces together, etc. Various synthetic fibers may be used to make fabrics suitable for receiving a deposited dry formulation thereon that may be applied or transferred to another fabric surface simply by wiping the applicator along the other fabric or surface. In some applications, it may be advantageous to form the applicator of fabrics of a color that is selected to mask the particles of dust, strands of hair, etc. that may be picked up by the applicating surface of the applicator as it is rubbed across the surface to dispense the dry formulation. In other applications, the applicating surface may include features or textures that attract or retain or adhere to such particles of dust or hair and the like that are encountered by the wipe, to enable their removal as well as freshening the surface being treated by the wipe.

Selection of the fragrance to be used in the formulation presents a different kind of task because the applicator may be adapted to a wide variety of uses simply by choosing a particular fragrance from among many that are available. Further, the proportion of the fragrance in the formulation may be varied depending on the circumstances of use of a specific embodiment of the wipe and characteristics of the fragrance. As is well known, fragrances are typically effective in relatively small amounts, such as ½% to 10% of a combination of ingredients for most applications and, in the present invention, may preferably be on the order of 1% to 5%, generally determined empirically.

As is well known to persons skilled in the art, fragrances or scents may be classified or categorized in several ways, depending on the use of the fragrance or the interests of the person or entity that organizes the categories. Most such categories will overlap to a strong degree. Thus masculine scents may include category members not present in feminine scent categories. Others may include both. Still others may include categories for determining industrial or cleaning uses of scents and fragrances.

For example, scents that may be found in cleaning products may include cedar, cinnamon, citrus, cotton, lemon, sage, etc., while scents for use in a dry clothing wipe as described herein may appropriately be selected from perfumes or colognes preferred by masculine or feminine users. Such scents or fragrances for the latter uses may be classified as floral, citrus, fougere (fern-like), woody, oriental, spice, etc. Still others may be categorized as clean cotton or clean linen to impart a freshened or clean scent to one's clothing—not unlike freshly laundered clothing—after using the wipe.

Neutralizing odors using fragrances or scents can be accomplished either by chemical interaction of the scent compound with the molecules of the malodor, or by masking or covering the malodor with a stronger but pleasant scent. Both methods are suitable for use in clothing wipes as described herein and other forms of wipes using a dry formulation. In some special applications special scents may be developed, and some embodiments may even be available with an array of optional scents.

Producing or formulating a fragrance having a given scent typically involves mixing selected essential or fragrance oils in predetermined proportions. Essential oils are volatile or aromatic liquid extracts from plants. Synthetic “fragrance oils” mimic the aromatic aspects of botanical oils. The resulting mixture may be mixed with alcohol and or distilled water. The resulting scent or fragrance is then combined with the base component of the odor neutralizing formulation, which may be the mixture of the polyethylene glycol (PEG) and glycerin, for use on the clothing wipe disclosed herein.

The dry wipe technology described herein may be adapted to a wide variety of applications for freshening surfaces of a person's skin, hair; or surfaces of household or office furnishings, appliances, and fixtures; or the hair, fur, or feathers of pets such as dogs, cats, rabbits and other rodents, birds, etc.; or the surfaces in the interiors of automobiles, trucks, airplanes, boats, and the like. Most such adaptations are easily accomplished by varying the size of the applicator, the materials used in its construction, or the formulation and the accompanying fragrance selected for the particular intended surface application.

For example, a home or office wipe may require a larger applicator such as a mitt to accommodate a person's entire hand, which is basically a scaled up version of the applicators depicted in the drawings herein, including the open-ended construction of FIGS. 8, 9, and 10, or the single-ended embodiment shown in FIGS. 1 through 4. A dry wipe for household surfaces may be configured by appropriate selection of size, fabric, and formulation to adapt to freshening the surfaces of any and all articles found in homes or offices without limitation such as tables, counters, cabinets, chests, chairs, sofas, bedding, rugs or carpets, lamps, appliances. TV and electronic equipment, baskets for laundry and trash, and decorative objects. Fragrances adapted for household dry wipes may preferably be provided with an outdoor “fresh air” scent or, for another example, the ever-popular lemon scent frequently used in wet wipe formulations.

In a further embodiment of a dry wipe adapted to uses on pets—dogs, cats, rodents, even pet birds, for example—the applicator may be provided in the same size as for the personal clothing wipe depicted herein or in a larger, “mitt-sized” applicator that can accommodate a person's hand. Such a wipe would have a fragrance adapted to the particular animal, one for dogs, another for cats, perhaps unscented for animals that might be sensitive to particular fragrances, etc. The wipe may also be configured structurally to better suit the surface being treated, as in the case of pets or other animals with fur, hair, or feathered skin. In other words, the bottom, applicating side of the wipe may be configured differently than a clothing wipe for personal (human) use. For example, the bottom layer of the applicator may have a texture or a rough, nappy surface, or be configured with an array of bristles (as in a brush) so that it more readily picks up particles of dust or hair, etc. during use while freshening a surface. Alternatively, the bottom portion of the applicator may be configured with a comb-like structure in combination with the dry odor neutralizing formulation to enable use of the dry wipe to transfer the formulation to the hair or fur of a pet animal during grooming. In other embodiments the bottom layer or fabric of the applicator, which is impregnated or otherwise includes the dry formulation deposited thereon, may be configured with alternating strips of the normal fabric described above situated between strips of textured or bristled material, or nappy fabric. In yet another example, the bottom layer or portion of the applicator may be a darker color so that particles of dust or hair or feathers that adhere to the wipe during use might be less visible.

Yet another alternate embodiment of a dry wipe may be configured for use to neutralize the odors that accumulate or otherwise become deposited on the interior surfaces of an automobile, truck, aircraft or other vehicle. Such a dry wipe might preferably be provided with a hand mitt-sized applicator because of the convenience of the larger area of the applicator and its ability to be installed on a person's hand. The bottom layer of the applicator and the fragrance used may be provided in several versions, each adapted to use with a different kind of surface that might be encountered in the interior of the vehicle, such as fabrics of different textures, leather, hard, polished trim surfaces, etc. Again, the bottom portion of the applicator having the dry formulation in combination therewith may be specifically configured to best adapt it to the surface being treated with the dry odor neutralizing formulation.

The foregoing description of a number of additional alternate embodiments is provided to illustrate the scope of the concepts and principles of the present invention as set forth in the appended claims. Some examples of structures and materials that are equivalents as they are expressed in the various distinct embodiments that share all of the same concepts and principles. Persons skilled in the art will recognize the existence of and be familiar with alternatives to each of the materials suggested herein. In other words, the fabrics and their equivalents, the polyethylene glycol (PEG) and its equivalents, the glycerin and its equivalents, the fragrances or malodor counteractants and their equivalents, as each is selected for use in the particular embodiment of the invention appropriate to the surface desired to be treated—i.e., freshened—with the dry formulation wipe described herein, are all contemplated in the foregoing description.

For example, the polyethylene glycol (PEG) material used as a thickening agent and carrier in the dry wipes described herein is a hydrophillic compound having a range of molecular weights and viscosities from liquid through solid. In the present invention it is preferred that PEG compounds, or acceptable substitutes therefor, of medium to moderately high molecular weight, e.g., within the range of 2000 to 7000 g/mol and preferably approximately 4000 g/mol, or at least semi-solid consistency be used such that the combined formulation is essentially dry when the applicator is removed from its storage pouch for use on an intended surface. The glycerin is added to improve the smoothness, uniformity, and spreadability of the formulation. Other odorless, viscous supplements may be used as long as the mixture of the base material such as the PEG or its substitute and the supplement used are compatible and the resulting mixture provides a suitably dry delivery vehicle for the fragrance or malodor counteractant from the surface of the applicator to the surface that is intended to be freshened by use of the wipe, whether, as appropriate, it is configured as a clothing wipe, a household wipe, a pet wipe, or an automotive interior wipe and the like.

What is claimed is:

1. A clothing wipe, comprising:
a mixture of polyethylene glycol (PEG), glycerin, and a fragrance, said mixture deposited as a dry formulation on a surface of a handheld applicator.

2. The clothing wipe of claim 1, wherein; said surface is an outer surface of said handheld applicator.

3. The clothing wipe of claim 1, wherein:
said PEG mixed with glycerin and a fragrance together form a dry odor neutralizing formulation.

4. The clothing wipe of claim 3, wherein:
said PEG having a molecular weight within the range of 2000 to 7000 g/mol.

5. The clothing wipe of claim 3, wherein:
said fragrance comprises a percentage of said dry odor neutralizing formulation within the range of 1% to 10% thereof.

6. The clothing wipe of claim 1, wherein:
said PEG, glycerin, and fragrance are mixed in approximate respective proportions of 17, 2, and 1 before being deposited on said surface.

7. The clothing wipe of claim 1, wherein:
said handheld applicator comprises a substrate layer and a second layer attached along first and second opposite sides of said substrate layer.

8. The clothing wipe of claim 7, wherein:
a finger space is provided between said substrate layer and said second layer.

9. The clothing wipe of claim 7, wherein:
said substrate layer is formed of a spun bonded synthetic fabric having a weight within the range of 100 to 200 g/m².

10. The clothing wipe of claim 7, wherein:
said substrate layer has a non-smooth surface texture.

11. The clothing wipe of claim 7, wherein:
said second layer is formed of a spun bonded synthetic fabric having a weight within the range of 50 to 150 g/m².

12. The clothing wipe of claim 1, further comprising:
a pouch for sealably enclosing said applicator when not in use.

13. The clothing wipe of claim 12, wherein:
said pouch is formed of packaging film and includes a resealable closure along one edge.

14. The clothing wipe of claim 12, wherein:
said pouch includes a string zipper along one edge.

15. A reusable clothing wipe for freshening a person's clothing, comprising:
a handheld applicator having a first outer surface; and
a dry odor neutralizing formulation deposited on said surface of said applicator.

16. The clothing wipe of claim 15, wherein said handheld applicator comprises: an applicator pad for dispensing said dry odor neutralizing formulation.

17. The clothing wipe of claim 15, wherein said handheld applicator comprises:
a finger mitt having first and second sides enclosing a finger space therebetween.

18. The clothing wipe of claim 17, wherein:
said first and second sides are bonded together along first and second opposite edges of said finger mitt.

19. The clothing wipe of claim 15, wherein:
said dry odor neutralizing formulation includes a base component and a fragrance component.

20. The clothing wipe of claim 19, wherein:
said base component comprises a mixture of polyethylene glycol and glycerin, respectively comprising 80% to 90% and 6% to 16% of said dry odor neutralizing formulation.

21. The clothing wipe of claim 20, wherein:
said fragrance component comprises 0.5% to 10.0% of said dry odor neutralizing formulation.

22. The clothing wipe of claim 19, wherein:
said fragrance component comprises an essential oil in combination with an aroma compound to provide a predetermined scent.

23. The clothing wipe of claim 22, wherein:
said aroma compound comprises a mixture of ingredients selected from the group consisting of an aldehyde, a ketone, an alcohol, an ester, an oxygen-containing material, and a sulphur-containing material.

24. The clothing wipe of claim 22, wherein said predetermined scent is characteristic of clean linen.

25. The clothing wipe of claim 15, further comprising:
a pouch for enclosing said applicator, said pouch formed of a packaging film and having a reusable closure mechanism along one side thereof.

26. The clothing wipe of claim 25, wherein said reusable closure mechanism is selected from the group consisting of a string zipper, a tongue-and-loop closure, and a closure flap.

27. The clothing wipe of claim 15, further comprising:
a pouch formed of a packaging film for sealably enclosing said applicator and having a reusable string zipper closure mechanism along one side thereof.
